(19) United States
(12) Patent Application Publication
(10) Pub. No.: US 2005/0074332 A1
(43) Pub. Date: Apr. 7, 2005

(54) Fan inlet plate and method

(76) Inventors: Stephen A. Adamski, Prospect Heights, IL (US); Eric S. Cole, St. Charles, IL (US); William J. Metzger, Crystal Lake, IL (US)

Correspondence Address: MICHAEL BEST & FRIEDRICH, LLP, 100 E WISCONSIN AVENUE, MILWAUKEE, WI, 53202, US

(21) Appl. No.: 10/679,960

(22) Filed: Oct. 6, 2003

(51) Int. Cl. F03B 1/00

(52) U.S. Cl. 415/211.1

(57) ABSTRACT

A fan inlet plate is provided in which a portion of the inlet plate is integral with and disposed at an angle with respect to the rest of the inlet plate to define a baffle of the fan. The portion of the inlet plate can be bent from the rest of the inlet plate. Also, the portion of the inlet plate can be at least partially cut from the rest of the inlet plate in order to facilitate bending of the portion as just described. An inlet structure for a fan housing is also provided, and has a first wall at least partially covering a side of the fan, and a second wall integral with the first wall and extending to inside the fan. In some embodiments, the first and second walls are integrally formed by a molding process.

### FIELD OF THE INVENTION

This invention relates generally to air and other fluid moving devices, and more particularly to fans, blowers, fan and blower housings, and methods for making the same.

### BACKGROUND OF THE INVENTION

The fundamental design of centrifugal fans and blowers has been largely unchanged for many years. Many conventional fans and blowers include an impeller or drum that rotates within a housing. Air or other fluid is drawn through an inlet opening in wall of the housing and rotation of the impeller or drum forces the air or other fluid out of the housing through an exit opening in a generally tangential direction. Various types of baffle arrangements can be attached to the housing and positioned in the inlet opening to condition the flow of air or other fluid into the housing and to improve the efficiency of the fan. Previously, baffles have been riveted, welded, or otherwise attached to a wall of the housing to form a two-piece plate/baffle assembly.

### SUMMARY OF THE INVENTION

For ease of description, the term “fan” as used herein and in the appended claims refers both to fans and blowers, it being understood that the present invention is applicable to both such units. Similarly, for ease of description, the term “air” as used below refers to any fluid that can be moved by a fan, it being understood that the present invention is applicable to fans used for moving any fluid.

Some embodiments of the present invention provide an inlet plate for a fan housing, wherein the inlet plate has a one-piece unitary body having a first portion defining an intake aperture positioned relative to a central axis and affording fluid flow into the housing, and a second portion integral and continuous with the first portion and extending at an angle with respect to the first portion in a direction toward an interior of the fan housing, the second portion defining an intake baffle for the fluid moving device.

In some embodiments, a one-piece inlet plate for a fan housing is provided, wherein the inlet plate includes a first, generally planar wall defining an intake aperture positioned relative to a central axis, and a second, generally planar wall extending inwardly with respect to the aperture at an angle with respect to the first wall, the second wall meeting the first wall along a transition line.

In another aspect of the present invention, a method for making an inlet plate for a fan is provided. In the method, an aperture is formed in a plate, and the plate is bent along a line to define a first wall surrounding the aperture and a second wall at an angle with respect to the first wall and extending inwardly with respect to the aperture and the fan housing, wherein the second wall is angled with respect to the first wall.

Some embodiments of the present invention provide an inlet structure for a fan housing adapted to enclose a fan, wherein the fan housing has an inlet side through which fluid is received into the fan housing, and wherein the inlet structure comprises a first wall located adjacent the fan, at least partially covering a side of the fan, separated from the side of the fan by a clearance distance, and at least partially surrounding an inlet aperture leading to an internal chamber in the fan housing; and a second wall integral with the first wall and extending from the inlet aperture to a location inside the fan within the fan housing.

Also, some embodiments of the present invention provide a method of creating an inlet structure for a fan housing adapted to enclose a fan having an intake side through which fluid moves during operation of the fan, wherein the method comprises forming a first wall of the fan housing, the first wall adapted to at least partially cover the intake side of the fan and to cooperate with other walls of the fan housing to enclose the fan; forming an aperture in the first wall, the aperture defining an intake aperture through which fluid enters the fan housing; and forming a second wall of the fan housing integral with the first wall and extending into the internal chamber of the fan housing, the second wall terminating at a location inside the fan.

Other features and advantages of the invention will become apparent from the following detailed description of the invention and claims, when taken in conjunction with the accompanying drawings, wherein like elements have like numerals throughout the drawings.

### BRIEF DESCRIPTION OF THE DRAWINGS

The present invention is further described with reference to the accompanying drawings, which show an exemplary embodiment of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numerals indicate like parts:

FIG. 1 is a perspective view of a centrifugal fan including an inlet plate according to an exemplary embodiment of the present invention;

FIG. 2 is a plan view of the inlet plate of FIG. 1;

FIG. 3 is a side view of the inlet plate of FIG. 1;

FIG. 4 is a side view of the inlet plate viewed along line 4-4 of FIG. 2;

FIG. 5 is a plan view of a manufacturing blank for the inlet plate of FIG. 2, shown prior to a forming operation;

FIG. 6 is an enlarged view of a portion of the manufacturing blank illustrated in FIG. 5;

FIG. 7 is a perspective view of a centrifugal fan having an inlet side housing portion according to an exemplary embodiment of the present invention;

FIG. 8 is a interior perspective view of the inlet side housing portion illustrated in FIG. 7; and

FIG. 9 is another interior perspective view of the inlet side housing portion illustrated in FIGS. 7 and 8.

### DETAILED DESCRIPTION OF THE PREFERRED EMBODIMENT

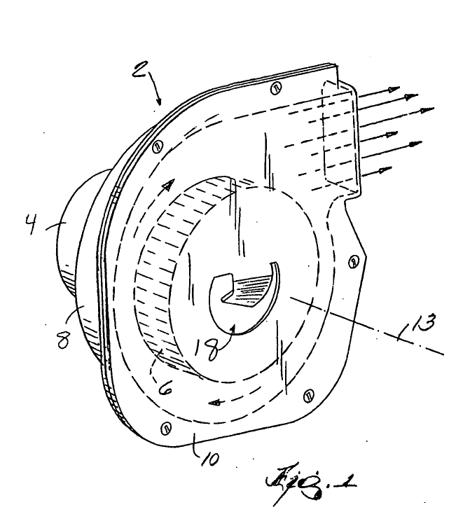

FIG. 1 illustrates a centrifugal fan assembly 2 including an electric motor 4, a fan wheel 6, a fan housing 8, and an inlet plate 10 according to an exemplary embodiment of the present invention. Although an electric motor 4 is illustrated, the fan assembly 2 can be powered in any other suitable manner, such as by a hydraulic motor, an engine, or any other conventional driving device. The electric motor 4 illustrated in FIG. 1 includes a drive shaft (not shown) coupled to the fan wheel 6 for rotating the fan wheel 6 about a central axis 13. The fan wheel 6 is generally surrounded by the fan housing 8 and the inlet plate 10. In the illustrated embodiment, the inlet plate 10 defines substantially one entire sidewall of the fan assembly 2. In operation, the electric motor 4 rotatably drives the drive shaft and the fan wheel 6. The rotating fan wheel 6 draws air into the fan housing 8 through an intake aperture 18 in the inlet plate 10, and discharges the air from the fan housing 8 in a direction that is generally tangential with respect to the outer circumference of the fan wheel 6 (see FIG. 1).

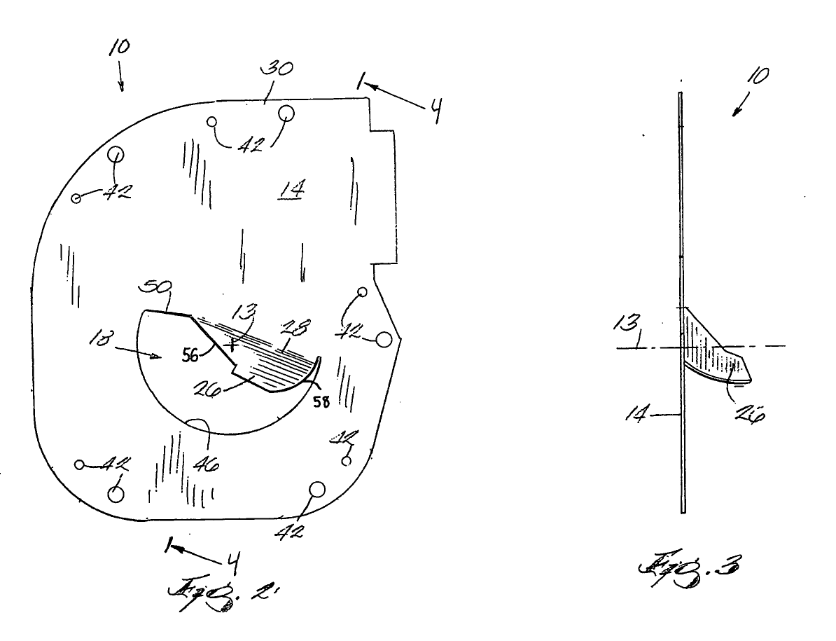

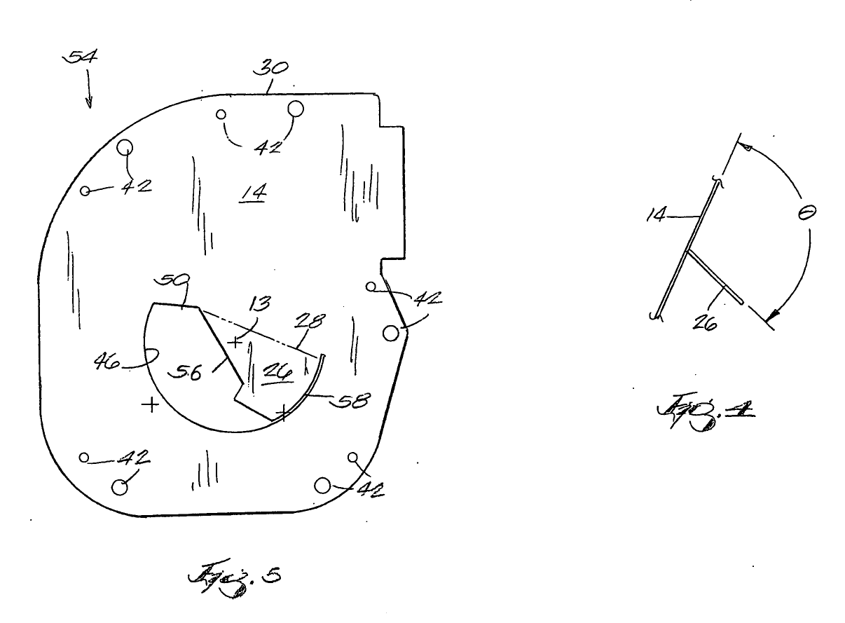

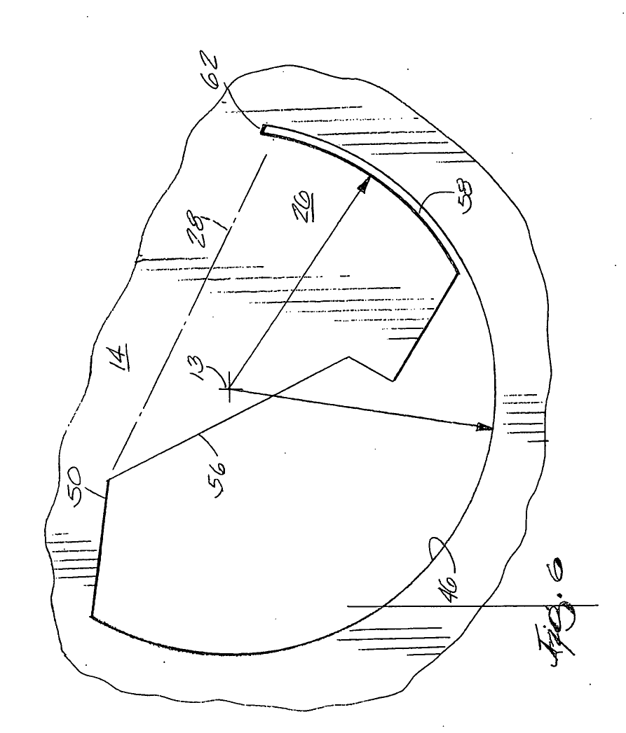

FIGS. 2 and 3 illustrate the inlet plate 10 of FIG. 1 in greater detail. The illustrated inlet plate 10 includes a first substantially planar wall 14 in which the intake aperture 18 is defined. The intake aperture 18 is positioned relative to the central axis 13 of the drive shaft, and therefore to the fan wheel 6. The inlet plate 10 also includes a second substantially planar wall 26 that extends inwardly with respect to the inlet aperture 18 and is angled with respect to the first wall 14 (see FIGS. 3 and 4). The first wall 14 and the second wall 26 are continuous with one another and are delimited by a transition line 28, which defines a boundary between the first wall 14 and the second wall 26. In this regard, the first and second walls 14, 26 can be formed from a common plate of material by a forming operation (e.g., a bending operation) as described further below.

The inlet plate 10 can be fabricated from substantially any material or combination of materials, including without limitation steel, aluminum, tin, and other metals, composites, polymers, ceramics, and the like. Although the inlet plate 10 illustrated in FIGS. 1-6 can be manufactured in any manner, the inlet plate 10 is particularly well-suited for being manufactured from a single piece of sheet material formed into the shape of the inlet plate described herein and illustrated by way of example in the figures. Any type of sheet material can be employed, such as a sheet of a single material, a laminate sheet of one or more materials, and the like. A number of advantages are realized in those embodiments of the present invention in which one or more bending, stamping, pressing or other sheet forming operations are performed on a single sheet of material to define the first and second walls 14, 26 of the inlet plate 10. These advantages can include significant cost savings, improved structural integrity, and reduced manufacturing and assembly time of the fan housing 8 using conventional sheet bending or other sheet forming equipment and processes.

The inlet plate 10 in the illustrated embodiment includes an outer peripheral edge 30 that is contoured to correspond to the shape of the fan housing 8, although such a shape correspondence is not required to practice the present invention. The outer periphery of the inlet plate 10 can have any shape desired, and in the illustrated embodiment is shaped to correspond to a scroll shape of the fan housing 8. The upper right portion of the inlet plate 10 in FIG. 2 corresponds to the location of a discharge opening of the fan housing 8 (see FIG. 1).

In some embodiments of the present invention (such as that illustrated in the figures), a plurality of mounting apertures 42 are formed in the inlet plate 10 for mounting the fan housing 8 in a desired location and orientation and/or for securing the inlet plate 10 to the rest of the fan housing 8. These mounting apertures 42 can be located anywhere in the inlet plate 10 as desired, and in some embodiments are located along the outer peripheral edge 30 of the inlet plate 10. The mounting apertures 42 are configured to receive fasteners (not shown) for mounting the fan housing 8 as described above and/or for securing the inlet plate 10 to the fan housing 8. The mounting apertures 42 can also be used to secure the entire fan assembly 2 to an additional piece of equipment, such as a furnace, for example. Of course, the specific size and location of the mounting apertures 42 are selected to correspond to the specific fan housing 8 to which the inlet plate 10 is to be secured and/or to desired mounting locations and orientations of the fan housing 8.

Multiple sets of mounting apertures 42 can be provided such that one inlet plate 10 can be fitted to a variety of fan housings. Alternatively or in addition, multiple sets of mounting apertures 42 can be provided such that a fan housing 8 employing the inlet plate 10 can be mounted to different devices, in different orientations, and the like. As such, it is not necessary for all the mounting apertures 42 to be utilized when securing the inlet plate 10 to the fan or when mounting the fan housing 8 (depending upon the purpose of the apertures 42 as described above).

The inlet plate shape, outer peripheral edge 30, and mounting aperture 42 configurations described above are presented by way of example only. It should be appreciated that the shape of the inlet plate 10, and the shape, contour, and location of the outer peripheral edge 30 and the mounting apertures 42 can vary greatly. In particular, the inlet plate 10 need not necessarily be substantially flat as illustrated in the figures (with the exception of the wall 26 described in greater detail below). The inlet plate 10 can have any planar or non-planar shape desired. Also, the inlet plate 10 need not necessarily have a peripheral shape that matches the contour of the rest of the fan housing 8 in all or some locations, and need not necessarily have radiused corners or corners with different radii of curvature. The inlet plate 10 can have any peripheral shape desired (with or without sharp or rounded corners).

In addition, the inlet plate 10 need not necessarily fully define a full wall of the fan housing 8 as described above, and can instead define part of a fan housing wall. Also, the inlet plate 10 can define more than one wall of the fan housing 8, such as by defining the back wall and part or all of the peripheral side wall of the fan housing 8. For example, in some embodiments the inlet plate 10 can define any portion of a fan housing 8 to emulate any two-piece fan housing design.

With continued reference to the illustrated exemplary embodiment of the present invention, the intake aperture 18 is defined in part by a first arcuate edge 46. The illustrated edge 46 has a substantially constant radius of curvature with respect to the central axis 13. However, in other embodiments the first arcuate edge 46 can be centered about a different axis that is not necessarily aligned with the rotational axis 13, can have a radius of curvature that is larger or smaller than that shown in the illustrated embodiment, and can have a non-constant radius of curvature, if desired. The first arcuate edge 46 in the illustrated embodiment is substantially semi-circular, and extends through an angle of slightly greater than 180 degrees. An additional substantially linear edge 50 cooperates with the bend line 28 to define the remaining outer edges of the intake aperture 18. As illustrated, the linear edge 50 and the bend line 28 extend generally chordally with respect to the first arcuate edge 46, thereby defining a substantially D-shaped profile of the intake aperture 18.

With reference to FIG. 5, a sidewall blank 54 used for producing the inlet plate 10 in at least one embodiment of the present invention is illustrated. The blank 54 can be formed using various manufacturing techniques such as stamping, laser cutting, water cutting, machining, casting, pressing, molding, and the like either alone or in combination. The blank 54 can be produced with the outer peripheral edge 30 and the mounting apertures 42 defined prior to execution of forming operation(s) for the wall 26 described below. Alternatively, the shape of the second wall 26 can be defined when the outer peripheral edge 30 and/or mounting apertures 42 are defined.

In some embodiments, one or more incisions are made in the blank 54 that form the first arcuate edge 46, the linear edge 50, and an outer profile 56 of the second wall 26. These incisions can be formed simultaneously with, and by the same manufacturing operation as the outer peripheral edge 30 and the mounting apertures 42. Alternatively, these incisions can be made at a different time and/or by other manufacturing operations as used in defining the outer peripheral edge 30 and the mounting apertures 42.

The outer profile 56 of the second wall 26 can include a second arcuate edge 58 (see FIG. 6) that is substantially concentric with the first arcuate edge 46, and, in the illustrated embodiment, has a radius equal to at least about 80% of the radius of the first arcuate edge 46 (although smaller percentages are possible). In some embodiments, this radius is equal to at least about 95% of the radius of the first arcuate edge 46. In some embodiments, the difference between the radii of the first arcuate edge 46 and the second arcuate edge 58 is determined at least in part by the thickness or cutting thickness of an implement. In such cases, both edges 46, 58 can be defined by same incision or forming operation in the inlet plate 10. For example, if a water jet is used to form the incision, the thickness of the jet of water that penetrates the inlet plate 10 can be on the order of twenty-thousandths of an inch. As such, for a desired first arcuate edge radius of about 1.89 inches, the resultant second arcuate edge radius will be about 1.87 inches. In this example, the second arcuate edge radius is about 99% of the first arcuate edge radius. In other embodiments of the present invention, the edges 46, 58 are produced by two different manufacturing operations (e.g., different incisions, different milling tool paths, and the like).

Although the outer profile 56 and edge 46 described above are substantially arcuate, the profile 56 and edge 46 can take on substantially any contour desired and need not necessarily be similar to one another in shape. For example, the edge 46 could be arcuate and the profile 56 could be at least partially defined by one or more straight lines (and vice versa). Regardless of the shape of the second wall (e.g., square, round, trapezoidal, irregular, and the like), the edges of the second wall 26 can be located any distance from the edge(s) 46—or by no distance at all. Also, the gap between the edge 46 and the profile 56 can take on a variety of sizes and shapes, and can vary along the edge 46.

FIG. 6 also reveals that the transition line 28 intersects the second arcuate edge 58 at a position spaced from a terminal edge 62 that extends between the first and second arcuate edges 46, 58. Although the first and second arcuate edges 46, 58 need not necessarily extend to this degree (e.g., the terminal edge 62 can be substantially aligned with the transition line 28), the location of the terminal edge 62 better enables the second sidewall 26 to be bent or otherwise formed out of plane of the first wall 14. In other words, the portion of the second arcuate edge 58 that extends between the transition line 28 and the terminal edge 62 better enables the sidewall blank 54 to be bent or otherwise formed so that the second wall 26 is at an angle with respect to the first wall 14. In the illustrated exemplary embodiment, the incision and transition line 28 cooperate to provide a second wall 26 having a generally triangular profile. However, other shapes and profiles of the second wall 26 are possible as well. For example, although the illustrated transition line 28 extends in a substantially straight manner, the transition line 28 can be curved, can be defined by two or more curved and/or straight lines defining a transition between the first and second walls 14, 26, and the like. Such different transition lines 28 can therefore define different planar and non-planar shapes of the second wall 26. Furthermore, regardless of the shape of the transition line 28, the second wall 26 can be formed to have substantially any shape, including planar, non-planar, and combinations of planar and non-planar shapes, without limitation.

To form the inlet plate 10 from a sidewall blank 54 according to some embodiments of the present invention, the first wall 14 is held substantially fixed and the second wall 26 is bent out of the plane of the first wall 14 along the transition line 28. In other embodiments, the second wall 26 is machined, cast, molded, pressed, or otherwise fabricated to be out of plane of the first wall 14 by a desired amount. The second wall 26 can be bent to (or otherwise fabricated having) an angle θ of at least 90 degrees and less than 180 degrees. In some embodiments, an angle θ of at least 90 degrees and less than 130 degrees provides good fan results. Also, in some embodiments such as that illustrated in FIG. 4, the second wall 26 can be bent or otherwise fabricated having an angle θ of about 112 degrees with respect to the first wall 14. However, a variety of other angles θ can be selected depending at least partially upon the particular application.

The inlet plate 10 illustrated in the drawings and described above is presented by way of example only. Many variations on the inlet plate 10 are possible, including variations to the outer peripheral edge 30, variations to the size, shape, and positioning of the intake aperture 18, variations to the size shape, and angle θ of the second wall 26, and variations to the locations and sizes of the mounting apertures 42. By way of example only, in some embodiments the intake aperture 18 is at least partially defined by an arc of constant or non-constant radius. In such cases, the arc can extend any amount to define any amount of the intake aperture 18 (e.g., arcs greater than or less than 180 degrees), in which case the remainder of the intake aperture can be defined partially or entirely by the edges of the second wall 26, and can also be defined by one or more additional edges. In this regard, it should be noted that the intake aperture 18 according to the various embodiments of the present invention can be defined entirely or substantially entirely by an arcuate edge (generated by a cut or other manufacturing process as described above) and edges of the second wall 26 disposed at an angle with respect to the first wall 14. In such cases, no additional edge (e.g., edge 50) need exist. However, the intake aperture 18 can be shaped to have such additional edge(s) depending at least partially upon the desired shape of the second wall 26.

In those embodiments of the present invention in which one or more edges 50 are employed in addition to an arcuate edge 46 and the edges of the second wall 26 to define the intake aperture 18, such other edge(s) need not necessarily be straight as shown in the illustrated embodiment, and can instead be curved, irregularly shaped, or have any other shape desired. The additional edge(s) can be aligned with transition line 28 or can be oriented at any angle with respect thereto.

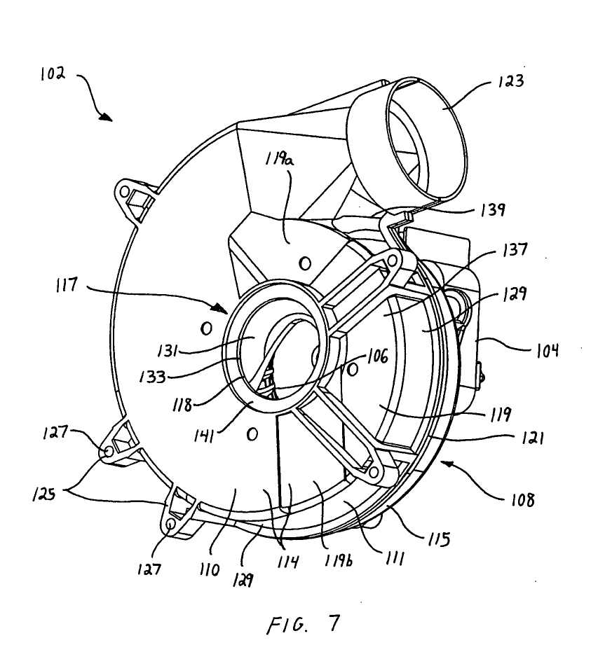

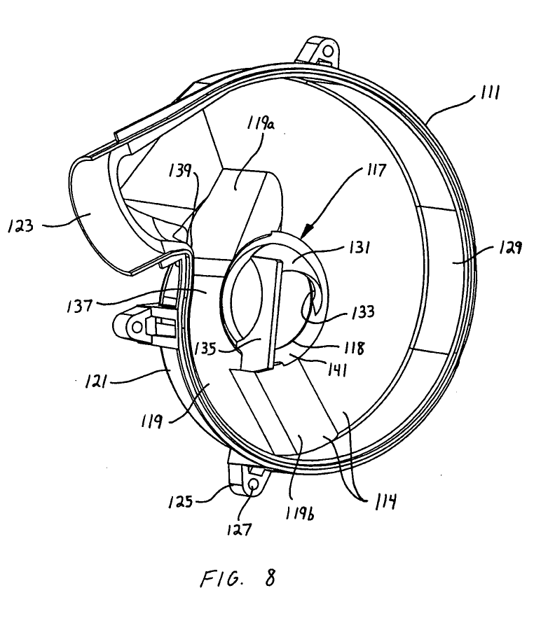

FIGS. 7-9 illustrate another embodiment of the present invention, and is similar in many ways to the embodiments described above and illustrated in FIGS. 1-8. Accordingly, with the exception of mutually inconsistent features and elements between the embodiment of FIGS. 7-9 and the embodiment of FIGS. 1-6, reference is hereby made to the description above regarding the embodiment of FIGS. 1-6 for a more complete description of the features, elements, and alternatives of the embodiment of FIGS. 7-9. Features and elements in the embodiment of FIGS. 7-9 corresponding to features and elements in the embodiment of FIGS. 1-6 are numbered in the 100 series.

FIG. 7 illustrates a centrifugal fan assembly 102 including an electric motor 104, a fan wheel 106, and a two-piece fan housing 108 having first and second pieces 111, 115 (although the fan housing 108 can be constructed of any number of pieces). The first and second pieces 111, 115 are joined together in the embodiment of FIGS. 7-9 by a seam running circumferentially around the fan wheel 106, although other interfaces between the first and second pieces 111, 115 can be employed as desired. In this embodiment, the inlet plate 110 is defined by and is an integral part of the first housing piece 111.

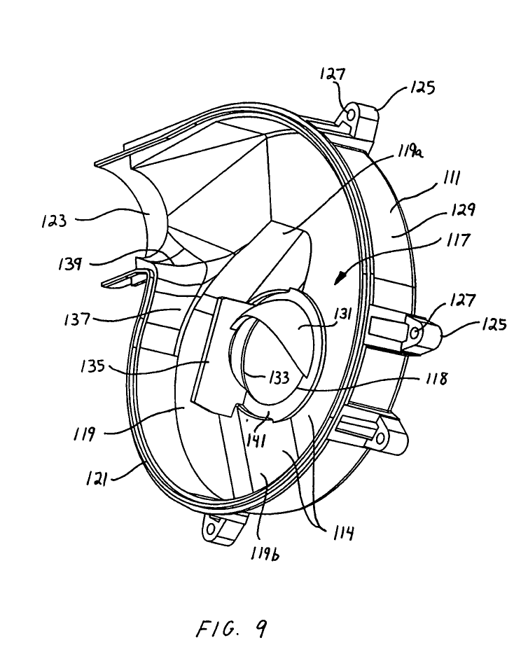

FIGS. 8 and 9 illustrate the first housing piece 111 and its inlet structure 117 in greater detail. The first housing piece 111 has a plurality of walls 114 covering a side of a fan wheel 106 in the fan housing 108. The plurality of walls 114 include at least one wall 119 recessed with respect to the other walls 114 (i.e., defining a narrower portion 121 of the fan housing 108 adjacent an outlet 123 of the fan housing 108). This narrower portion 121 of the fan housing 108 can extend any amount around an intake aperture 118 of the fan housing 108, and in some embodiments extends approximately half way around the intake aperture 118. In other embodiments, this narrower portion 121 extends less than half way around the intake aperture 118. The recessed wall(s) 119 can include transitional walls 1 19a,b joining the narrower portion 121 of the fan housing 108 to the remainder of the fan housing 108. The transitional walls 119a,b can be stepped, curved, ramped, or have any other shape providing a transition to and/or from the narrower portion 121 of the fan housing 108, and in the illustrated embodiment of FIGS. 8 and 9 includes two substantially planar walls providing transitional ramping walls for the narrower portion 121 of the fan housing 108.

Although the first housing piece 111 having the inlet structure 117 can have one or more recessed walls 119 as described above, it will be appreciated that the first housing piece 111 can have a single flat or substantially flat wall defining a side of the fan housing 108 with the inlet structure 117. In other embodiments, the first housing piece 111 can have one or more walls 114 that protrude from the housing 108 (rather than one or more recessed walls 119 as just described), thereby still defining different portions of the fan housing 108 having different widths in the axial direction of the fan housing 108.

The first housing piece 111 can have one or more mounting bosses 125 extending from the wall(s) 114, 119 to locations around a periphery of the fan housing 108. These mounting bosses 125 can have apertures 127 through which fasteners (not shown) can be passed to mount the fan housing 108 to a surface. Alternatively or in addition, mounting apertures can be located in walls 114, 119 of the first housing piece 111 for this same purpose. If employed, the mounting bosses 125 can be integral with the first housing piece 111. By way of example only, the mounting bosses 125 in the illustrated exemplary embodiment of FIGS. 7-9 extend from side walls 129 of the first housing piece 111 located around the radial periphery of the fan wheel 106 and extend from the recessed walls 119, 119a, 119b of the first housing piece 111. In other embodiments the mounting bosses 125 can be secured to a surface in any other manner, such as by rivets, pins, posts, and other conventional fasteners, clips, clamps, inter-engaging elements, or in any other suitable manner.

The inlet structure 117 of the embodiment illustrated in FIGS. 7-9 includes one or more walls 114, 119 (described above) and an intake wall 131 integral with the wall(s) 114, 119 and extending inwardly into the fan housing 108. The intake wall 131 can take any of the shapes described above with reference to the embodiment of FIGS. 1-6. The inlet structure 117 in the embodiment of FIGS. 7-9 has a curved intake wall 131 that in some embodiments has the shape of a sphere fragment presenting a convex surface to the interior of the fan housing 108 and a concave surface to an exterior of the fan housing 108. It will be appreciated that the intake wall 131 can have any other curved shape desired.

The intake wall 131 illustrated in FIGS. 7-9 extends from an edge 133 of the intake aperture 118 into the fan housing 108, and in some embodiments extends into a space within the fan wheel 106. The intake wall 131 can extend from any portion of the edge 133 of the intake aperture 118, such as from a portion of the edge 133 running at least half way around the intake aperture 118. In some embodiments, the intake wall 131 extends from a portion of the edge 133 running at least one quarter of the way around the intake aperture 118. In still other embodiments, an intake wall extending from a portion of the edge 133 running at least two-thirds of the way around the intake aperture 118 provides good performance results. In each embodiment, the intake wall 131 can be located at the edge 133 of the intake aperture 118 (as shown in FIGS. 7-9) or can be recessed with respect to the edge 133 of the intake aperture 118 (i.e., in a direction radially away from the edge 133 of the intake aperture).

The intake wall 131 can extend any depth into the fan housing 108 and fan wheel 106, and can have a uniform depth (i.e., axially into the fan housing 108) or can have a changing depth such as that shown in FIGS. 7-9. With particular reference to FIGS. 8 and 9 by way of example only, the depth of the intake wall 131 can vary gradually along the intake wall 131 in any manner, such as in a ramped, curved, stepped or other manner. In the case of the sphere fragment shape of FIGS. 7-9, the intake wall 131 has different depths at different circumferential positions around the intake aperture 118. As mentioned above, the intake wall 131 can have any other shape, including other curved shapes extending inwardly from the intake aperture 118, flat and substantially planar shapes, and any combination thereof.

In some embodiments, the inlet structure 117 of the present invention can include a baffle wall 135 extending axially from the intake wall 131 further into the fan housing 108 than the intake wall 131. The baffle wall 135 in the illustrated embodiment of FIGS. 7-9 is substantially flat and planar and has a generally rectangular shape extending further into the fan housing 108 and fan wheel 106 from a terminal edge of the intake wall 131 within the fan wheel 106. In other embodiments, the baffle wall 135 can take other shapes that are not necessarily substantially flat and planar, and are not necessarily rectangular in profile. The baffle wall 135 can extend from any terminal edge of the intake wall 131. However, in some embodiments the baffle wall 135 is located at a circumferential position (with respect to the axis of rotation of the fan wheel 106) of the fan housing 108 between the axis of rotation and the start of the fan scroll 137. The start of the fan scroll 137 can be defined in that portion of the fan housing 108 located immediately adjacent the fan cutoff 139.

The intake aperture 118 can be defined in the wall(s) 114, 119a, 119b of the fan housing 108 on an intake side of the fan wheel 106 as described above. In such cases, the intake wall 131 can be integral with and adjoin the wall(s) 114, 119a, 119b. In other embodiments however, the intake wall 131 can be separated from the wall(s) 114, 119a, 119b by another wall 141 at least partially surrounding the intake aperture 118 and recessed with respect to at least one of the other adjacent wall(s) 114, 119a, 119b. By way of example only, the intake aperture 118 of the inlet structure 117 in the illustrated embodiment of FIGS. 7-9 is recessed with respect to surrounding walls 114, 119a, 119b. Such a recessed portion of the fan housing 108 can facilitate easier connection of the fan housing 108 to upstream equipment.

Although the inlet structure 117 and fan housing 108 illustrated in FIGS. 7-9 can be manufactured in any manner, the inlet structure 117 and the portion of the fan housing 111 in which the inlet structure 117 is defined is particularly well-suited for being manufactured in one or more molding or casting operations. Any type of molding or casting operation can be employed, including without limitation injection molding, blow molding, spin molding, and the like. By molding or casting the inlet structure 117, the various portions of the inlet structure (e.g., the intake wall 131, intake aperture 118, baffle wall 135, housing walls 114, 119a, 119b) can be produced even if such portions have shapes that are complex or would otherwise be difficult or impossible to produce through other operations such as stamping, pressing, or machining. Accordingly, in some embodiments of the present invention, the inlet structure 117 described above and illustrated in the figures is made from molded or cast plastic or other synthetic material. Also, in some embodiments of the present invention, the fan housing portion 111 and the inlet structure 117 is manufactured (e.g., molded or cast) as a single integral structure. A number of advantages are realized in those embodiments of the present invention in which the inlet structure 117 is molded or cast as just described. These advantages can include significant cost savings, improved structural integrity, and reduced manufacturing and assembly time of the fan housing 108 using conventional molding and/or casting equipment and processes.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

For example, the intake aperture 18 in the embodiment of FIGS. 1-6 need not necessarily be defined in part by an arcuate edge 46 such as that shown in the illustrated embodiment. In this regard, in those embodiments in which the second wall 26 of the inlet plate 10 is bent from the first wall 14, the second wall 26 need not necessarily be defined by an arc-shaped cut (or other split) from the first wall 14. Instead, the intake aperture 18 and/or second wall 26 can have any shape desired, defined by any number of straight and/or curved lines, thereby defining a second wall 26 having any shape desired, including without limitation triangular, crescent or half-moon, rectangular, trapezoidal, irregular, and the like. In addition, the intake aperture 18 can have any shape desired, including those listed above with respect to the second wall. It should be appreciated however that the shape or shapes of the intake aperture 18 and the shape or shapes of the second wall 26 may or may not be similar to or generally correspond to one another, and can vary greatly from one another depending upon the particular application. By way of example only, the intake aperture can be shaped as shown in the figures, can be half-moon shaped, or can be defined by an arcuate cut or other separation in the inlet plate 10 that is less than or greater than 180 degrees—any of which can be used in conjunction with any of the second wall shapes described above. In those embodiments in which the intake aperture 18 and/or second wall 26 have one or more arcuate edges, such edges can have a constant or non-constant radius (centered about the axis of rotation 13 of the drive shaft or about any other point), can be defined by multiple radii, or can have any other curved shape desired.

As another example, the inlet plate 10 (with reference again to the embodiment of FIGS. 1-6 by way of example only) can define a wall of the fan housing 8, and can enclose a portion of the inner chamber of the housing 8 in which is located the fan wheel 6. However, it should be noted that the inlet plate 10 can instead be an element separate from a complete fan housing 8 and mounted with respect to the fan housing 8 to position the second wall 26 as described above. In this regard, the inlet plate 10 can be mounted upon a wall of the housing 8 having an inlet (e.g., by placing the inlet plate 10 in facing relationship against the wall of the housing 8 having the inlet) or can be mounted to adjacent equipment (e.g., a furnace or other structure) in a position and orientation such that a fan housing 8 can be mounted thereupon or thereover to receive the second wall 26 within the inlet of the fan housing 8. In some cases, the inlet plate 10 can even be integral with adjacent equipment (e.g., a furnace or other structure) to which the fan housing 8 is mounted. As used herein and in the appended claims, phrases such as “inlet plate for a fan housing”, “inlet plate for a fan”, and the like refer to all such types of inlet plates.

Also, it should be noted that a fan employing an inlet plate and inlet structure according to the present invention can be oriented in any manner desired. Accordingly, terms such as “front”, “back”, “top”, “bottom”, “side”, and other terms of orientation used herein and in the appended claims are used for purposes of description only and neither indicate nor imply any limitation regarding the orientation of the present invention.

1. An inlet plate for a fan housing, the inlet plate comprising:
a one-piece unitary body having
a first portion defining an intake aperture positioned relative to a
central axis and affording fluid flow into the housing; and
a second portion integral and continuous with the first portion and extending at an angle with respect to the first portion in a direction toward an interior of the fan housing, the second portion defining an intake baffle of the fan housing.

2. The inlet plate of claim 1, further comprising a plurality of mounting apertures located along an outer periphery of the first portion, the mounting apertures adapted to receive fasteners for securing the inlet plate to the housing.

3. The inlet plate of claim 1, wherein the first portion and the second portion share a common boundary defined by a transition line between the first and second portions.

4. The inlet plate of claim 1, wherein:
the second portion has a peripheral edge having a shape;
the aperture has a peripheral edge having a shape; and
at least part of the peripheral edge of the second portion matches the shape of at least part of the peripheral edge of the first portion.

5. The inlet plate of claim 3, wherein:
the intake aperture is at least partially defined by an arcuate edge; and
the transition line extends substantially chordally with respect to the arcuate edge, thereby providing the intake aperture with a substantially D-shaped profile.

6. The inlet plate of claim 1, wherein the intake aperture is at least partially defined by a first arcuate edge, at least part of the first arcuate edge having a substantially constant radius with respect to the central axis of the fan housing.

7. The inlet plate of claim 6, wherein the second planar wall includes a second arcuate edge having a radius that is at least about 80% of the substantially constant radius of the first arcuate edge.

8. The inlet plate of claim 7, wherein the second arcuate edge radius is at least about 95% of the substantially constant radius of the first arcuate edge.

9. The inlet plate of claim 1, wherein when the inlet plate is secured to the housing, and wherein the inlet plate substantially entirely defines one side wall of the housing.

10. A one-piece inlet plate for a fan, the one-piece inlet plate comprising:
a plate having:
a first, generally planar wall defining an intake aperture positioned relative to a central axis;
a second, generally planar wall extending inwardly with respect to the aperture at an angle with respect to the first wall, the second wall meeting the first wall along a transition line.

11. The one-piece inlet plate of claim 10, wherein the intake aperture is substantially D-shaped.

12. The one-piece inlet plate of claim 10, wherein the intake aperture includes a first arcuate edge, at least a portion of the first arcuate edge having a substantially constant radius.

13. The one-piece inlet plate of claim 12, wherein the transition line extends substantially chordally with respect to the first arcuate edge.

14. The one-piece inlet plate of claim 12, wherein the second planar wall includes a second arcuate edge having a radius that is at least about 80% of the substantially constant radius of the first arcuate edge.

15. The one-piece inlet plate of claim 12, wherein the second planar wall includes a second arcuate edge having a radius that is at least about 95% of the substantially constant radius of the first arcuate edge.

16. The one-piece inlet plate of claim 10, wherein the transition line is substantially straight.

17. The one-piece inlet plate of claim 10, wherein the inlet plate substantially entirely defines a sidewall of the fan when the inlet plate is secured to the fan.

18. A method for making an inlet plate for a fan having a housing, the method comprising:
providing a plate;
forming an aperture in the plate;
bending the plate along a line to define a first wall surrounding the aperture and a second wall at an angle with respect to the first wall and extending inwardly with respect to the aperture and the housing.

19. The method of claim 18, wherein forming an aperture in the plate includes defining at least part of a periphery of the second wall oriented substantially parallel to the first wall.

20. The method of claim 18, wherein forming an aperture in the plate includes separating an arcuately-shaped peripheral portion of the second wall from a matching peripheral portion of the first wall.

21. An inlet structure for a fan housing adapted to enclose a fan, the fan housing having an inlet side through which fluid is received into the fan housing, the inlet structure comprising:
a first wall located adjacent the fan and at least partially covering a side of the fan, the first wall separated from the side of the fan by a clearance distance and at least partially surrounding an inlet aperture leading to an internal chamber in the fan housing; and
a second wall integral with the first wall, the second wall extending from the inlet aperture to a location inside the fan within the fan housing.

22. The inlet structure of claim 21, wherein the first wall is contiguous the second wall.

23. The inlet structure of claim 21, wherein the first wall is separated from the second wall by a third wall recessed with respect to the first wall.

24. The inlet structure of claim 23, wherein the third wall surrounds and defines the inlet aperture.

25. The inlet structure of claim 22, wherein the first wall surrounds and defines the inlet aperture.

26. The inlet structure of claim 21, further comprising at least one additional wall extending from the first wall to at least partially surround an outermost radial periphery of the fan.

27. The inlet structure of claim 21, wherein the fan housing is a two-piece fan housing, the first wall, second wall, and at least one additional wall defining one piece of the two-piece fan housing.

28. The inlet structure of claim 21, further comprising at least one mounting boss integrally formed on the first wall.

29. The inlet structure of claim 21, wherein the second wall is a curved partially spherical wall recessed within the internal chamber of the housing.

30. The inlet structure of claim 29, further comprising a substantially planar baffle wall integral with the second wall and extending from the second wall to a location inside the fan.

31. The inlet structure of claim 21, wherein the fan is rotatable about an axis, the first wall having different portions located at different circumferential positions about the inlet aperture, the different portions located at different axial locations with respect to the inlet aperture.

32. The inlet aperture of claim 31, wherein the first wall is shaped to at least partially define an internal chamber cross-sectional area that increases in size in a range of different circumferential positions around the inlet aperture.

33. A method of creating an inlet structure for a fan housing adapted to enclose a fan having an intake side through which fluid moves during operation of the fan, the method comprising:
forming a first wall of the fan housing, the first wall adapted to at least partially cover the intake side of the fan and to cooperate with other walls of the fan housing to enclose the fan;
forming an aperture in the first wall, the aperture defining an intake aperture through which fluid enters the fan housing; and
forming a second wall of the fan housing integral with the first wall and extending into the internal chamber of the fan housing, the second wall terminating at a location inside the fan.

34. The method of claim 33, wherein forming the first wall, aperture, and second wall includes molding the first wall, aperture, and second wall as a single integral element.

35. The method of claim 33, wherein the first wall, aperture, and second wall are formed substantially simultaneously.

36. The method of claim 33, wherein forming the second wall includes forming the second wall contiguous the first wall.

37. The method of claim 33, further comprising forming a third wall intermediate and integral with the first and second walls, the third wall recessed with respect to the first wall.

38. The method of claim 37, wherein the third wall surrounds and defines the intake aperture.

39. The method of claim 33, wherein the first wall surrounds and defines the intake aperture.

40. The method of claim 33, further comprising forming at least one additional wall contiguous and integral with the first wall and extending around at least part of a radial periphery of the fan.

41. The method of claim 40, wherein the first wall, the aperture, the second wall, and the at least one additional wall are formed substantially simultaneously.

42. The method of claim 41, wherein:
the fan housing is a two-piece fan housing; and
the first wall, the second wall, and the at least one additional wall define one piece of the two-piece housing.

43. The method of claim 33, further comprising forming at least one boss on the first wall, the at least one boss adapted to receive at least one fastener for mounting the fan housing to a surface.
